(19) United States
(12) Patent Application Publication
(10) Pub. No.: US 2018/0371268 A1
(43) Pub. Date: Dec. 27, 2018

(54) WHITE INKJET INK COMPOSITION, INK COATING METHOD, AND COATED ARTICLE

(71) Applicant: CORNING INCORPORATED, Corning, NY (US)

(72) Inventors: Wen Zheng Chen, Tainan (TW); Guan Hao Huang, Tainan (TW); Ruei-ming Huang, Kaohsiung City (TW)

(21) Appl. No.: 16/003,717

(22) Filed: Jun. 8, 2018

Related U.S. Application Data
(60) Provisional application No. 62/525,258, filed on Jun. 27, 2017.

(51) Int. Cl. C09D 11/033; C09D 11/037; C09D 11/322; C09D 11/36; C09D 11/102; C09D 11/107; B41M 5/00; B41M 7/00

(52) U.S. Cl. CPC C09D 11/033; C09D 11/037; C09D 11/322; C09D 11/36; B41M 7/009; C09D 11/107; B41M 5/0023; B41M 5/0047; B41M 5/007; C09D 11/102

(57) ABSTRACT

A white inkjet ink composition, inkjet ink coating method, and resulting jet ink coated article are all predicated upon the white inkjet ink composition which includes a particulate pigment material, a resin composition, and a solvent composition. Upon thermal cure, the uncured resin composition forms a cured resin composition that adheres to substrates such as but not limited to glass substrates, glass-ceramic substrates, ceramic substrates, metal oxide substrates, metal substrates, and polymeric substrates.

### CROSS-REFERENCE TO RELATED APPLICATIONS

This application claims the benefit of priority under 35 U.S.C. § 119 of U.S. Provisional Application Ser. No. 62/525,258 filed on Jun. 27, 2017, the content of which is relied upon and incorporated herein by reference in its entirety.

### FIELD

The present disclosure is directed generally to inkjet ink compositions, inkjet-printed articles, and inkjet printing methods.

### BACKGROUND

Inkjet ink compositions for inkjet ink printing processes are well known materials that often provide precise and reproducible images on porous substrates such as paper stock substrates. Unfortunately, when applied to less porous substrates such as glass substrates, ink image adhesion and opacity are often compromised. For example, issues with ink adhesion to a less porous substrate like glass can lead to poor color density and image clarity, particularly with color inks.

Accordingly, there is a need in the art for inkjet ink compositions and printing methods that provide enhanced glass substrate adhesion properties and enhanced opacity properties.

### SUMMARY

The present disclosure is directed to inkjet ink compositions and printing methods that provide enhanced substrate adhesion properties and enhanced opacity properties, for example optical density. Embodiments described or otherwise envisioned herein are directed to inkjet ink compositions with a pigment component, a resin composition and a solvent composition that provide the cured inkjet ink composition with enhanced adhesion and enhanced opacity with respect to a substrate surface, in particular under circumstances where the substrate surface comprises a glass surface, a ceramic surface, a metal oxide surface, a metal surface, a polymeric surface, or similar surfaces. Similarly, embodiments of the method described or otherwise envisioned herein are directed to inkjet printing an ink composition with a pigment component, a resin composition and a solvent composition onto a substrate surface, such as a glass surface, a ceramic surface, a metal oxide surface, a metal surface, a polymeric surface, or similar surfaces.

In an aspect (1), an ink composition is disclosed comprising:
a white pigment material;
a resin composition comprising:
   a silicone resin component; and
   at least one of an amino resin component or an acrylic resin component; and
a solvent composition comprising one or more of a propylene-glycol-ether, diethylene-glycol-dimethyl-ether, propylene-glycol-methyl-ether-acetate, or diethylene-glycol-diethyl ether.

An aspect (2) according to aspect (1), wherein the ink composition is inkjet printable and thermally curable.

An aspect (3) according to aspect (1) or (2), wherein the white pigment material comprises a titanium dioxide powder having an average particle size D50 in a range from 100 nm to 250 nm.

An aspect (4) according to aspect (3), wherein the average particle size D50 is in a range from 150 nm to 250 nm.

An aspect (5) according to any preceding aspect, wherein the silicone resin component comprises a silsesquioxane.

An aspect (6) according to aspect (5), wherein the silsesquioxane is divinyl-hexamethyl-octasila-silsesquioxane.

An aspect (7) according to any preceding aspect, wherein the solvent composition comprises two or more of a propylene-glycol-ether, diethylene-glycol-dimethyl-ether, propylene-glycol-methyl-ether-acetate, or diethylene-glycol-diethyl ether.

An aspect (8) according to any preceding aspect, wherein the solvent composition comprises three or more of a propylene-glycol-ether, diethylene-glycol-dimethyl-ether, propylene-glycol-methyl-ether-acetate, or diethylene-glycol-diethyl ether.

An aspect (9) according to any preceding aspect, wherein the solvent composition comprises propylene-glycol-ether, diethylene-glycol-dimethyl-ether, propylene-glycol-methyl-ether-acetate, and diethylene-glycol-diethyl ether.

An aspect (10) according to any preceding aspect, wherein the propylene-glycol-ether is propylene-glycol-monomethyl-ether.

An aspect (11) according to any preceding aspect, further comprising: a dispersant; and a flow promoter.

An aspect (12) according to aspect (11), wherein the flow promoter comprises modified polyether polydimethylsiloxane.

An aspect (13) according to any preceding aspect, wherein the resin composition comprises an amino resin component and an acrylic resin component.

An aspect (14) according to any preceding aspect, wherein the resin composition further comprises an epoxy resin component.

An aspect (15) according to any preceding aspect, comprising:

the pigment material in a range from 9 to 14 weight percent;

the silicone resin component in a range from 12 to 25 weight percent;

the amino resin component in a range from 0 to 10 weight percent;

the acrylic resin component in a range from 0 to 10 weight percent;

the propylene-glycol-ether in a range from 15 to 25 weight percent;

diethylene-glycol-dimethyl-ether in a range from 10 to 20 weight percent;

diethylene-glycol-diethyl ether in a range from 0 to 10 weight percent; and

propylene-glycol-methyl-ether-acetate in a range from 13 to 25 weight percent.

An aspect (16) according to aspect (15) further comprising:

a dispersant in a range from 1 to 4 weight percent;

a flow promoter in a range from 0.5 to 3.5 weight percent; and

an epoxy resin component in a range from 0 to 10 weight percent.

In an aspect (17) ink coating method comprises the steps of:

coating upon a substrate an uncured inkjet ink composition of any preceding aspect; and curing in-situ the uncured inkjet ink composition to form a cured ink composition upon the substrate.

An aspect (18) according to aspect (17), wherein the substrate is selected from the group consisting of a glass substrate, a glass-ceramic substrate, a ceramic substrate, a metal oxide substrate, a metal substrate, and a polymeric substrate.

An aspect (19) according to aspect (17) or (18), wherein the uncured inkjet ink composition is thermally cured to form the cured ink composition.

An aspect (20) according to any one of aspect (17)-(19), wherein the cured ink composition has an optical density in a range from greater than 0.2 to 1.0.

An aspect (21) according to aspect (20), wherein the cured ink composition has an optical density in a range from greater than 0.5 to 1.0.

In an aspect (22) a coated article comprises: a substrate; and a cured coating located upon the substrate, the cured coating comprising the ink composition of any one of aspects (1)-(16).

An aspect (23) according to aspect (22), wherein the cured coating has a thickness in a range from 1 micron to 10 microns.

An aspect (24) according to aspect (22) or (23), wherein the cured coating has an optical density in a range from greater than 0.2 to 1.0.

An aspect (25) according to aspect (24), wherein the cured coating has an optical density in a range from greater than 0.5 to 1.0.

An aspect (26) according to any one of aspects (22)-(25), wherein the adhesion of the cured coating to the substrate is greater than or equal to 4B according to a cross hatch adhesion test set forth in ASTM D3359-09e2.

In an aspect (27) an electronic device comprises the coated article of any one of aspects (22)-(26).

These and other aspects of the invention will be apparent from and elucidated with reference to the embodiment(s) described hereinafter.

### BRIEF DESCRIPTION OF THE DRAWINGS

The objects, features and advantages of the embodiments are understood within the context of the Detailed Description, as set forth below. The Detailed Description is understood within the context of the accompanying drawings, where like reference characters generally refer to the same parts throughout the different views. Also, the drawings are not necessarily to scale, emphasis instead generally being placed upon illustrating the principles of the invention.

FIG. 1 is a schematic representation of the chemical structure of a divinyl-hexamethyl-octasila-silsesquioxane resin component, in accordance with some embodiments.

FIG. 2 is a thermal desorption gas chromatogram mass spectroscopy (GC/MS) spectrum of the divinyl-hexamethyl-octasila-silsesquioxane resin component, in accordance with some embodiments.

### DETAILED DESCRIPTION

Embodiments described or otherwise envisioned herein are directed to white inkjet ink compositions and printing methods that provide enhanced substrate adhesion properties and enhanced opacity properties, for example optical density. According to various embodiments, the inkjet ink compositions include a pigment component, a resin composition, and a solvent composition that provide the cured inkjet ink composition with enhanced adhesion and enhanced opacity with respect to a substrate surface, in particular under circumstances where the substrate surface comprises a glass surface, a glass-ceramic surface, a ceramic surface, a metal oxide surface, a metal surface, a polymeric surface, or similar surfaces. According to various embodiments, the inkjet printing methods described herein utilize a series of steps to inkjet an ink composition with a pigment component, a resin composition and a solvent composition onto a substrate surface, such as a glass surface, a glass-ceramic surface, a ceramic surface, a metal oxide surface, a metal surface, a polymeric surface, or similar surfaces. In some embodiments, the white inkjet ink composition has a suitable viscosity (for example, from 2 to 6 centipoise) and a suitable average particle size D50 for the pigment material (for example, from 100 to 250 nm) such that the white inkjet ink composition is inkjet printable. In some embodiments, the white inkjet ink composition is thermally curable.

Inkjet printing also provides an ability to print on 3D-shaped or 2.5D-shaped substrates, which is not easily achieved or not possible with other printing techniques such as screen printing. Screen printing relies on the use of a screen where ink is applied to the substrate by squeezing the ink through openings in the screen with a squeegee. The screen needs to be in full contact with the substrate in order to perform the screen printing process, which results in limited or no capability for some 3D-shaped and 2.5D-shaped substrates. On the other had, inkjet printing does not require the printhead to contact the substrate, but rather that the printhead be perpendicular to the substrate surface. 3D-shaped substrates include substrates where both major surfaces of the substrate have curvature, for example at one or more edges of the substrate. 2.5D-shaped substrates include substrates where only one major surface has curvature, for example at one or more edges of the substrate. In some embodiments, a substrate may have 4 edges and the substrate may have curvature at 1, 2, 3, or all 4 edges. In some embodiments, the ink compositions disclosed herein are compatible with inkjet printing on 3D-shaped and 2.5-D shaped substrates.

In some embodiments, the inkjet ink composition comprises a white pigment material; a resin composition comprising: a silicone resin component; and at least one of an amino resin component or an acrylic resin component; and a solvent composition comprising one or more of a propylene-glycol-ether, diethylene-glycol-dimethyl-ether, propylene-glycol-methyl-ether-acetate, or diethylene-glycol-diethyl ether.

Inkjet Ink Compositions

An uncured inkjet ink composition in accordance with some embodiments includes a pigment material that may comprise, but is not limited to, a white pigment material. In some embodiments, the white pigment material is a titanium dioxide (TiO2) powder. In some embodiments, the pigment material has a suitable average particle size D50 to permit inkjet printing of the uncured inkjet ink composition with reduced or minimal clogging of the inkjet printhead. In some embodiments, the titanium dioxide powder has an average particle size D50 in a range from 100 nm to 250 nm, 100 nm to 225 nm, 100 nm to 200 nm, 100 nm to 175 nm, 100 nm to 150 nm, 100 nm to 125 nm, 125 nm to 250 nm, 125 nm to 225 nm, 125 nm to 200 nm, 125 nm to 175 nm, 125 nm to 150 nm, 150 nm to 250 nm, 150 nm to 225 nm, 150 nm to 200 nm, 150 nm to 175 nm, 175 nm to 250 nm, 175 nm to 225 nm, 175 nm to 200 nm, 200 nm to 250 nm, 200 nm to 225 nm, 225 nm to 250 nm, or any ranges and subranges therebetween. The average particle size D50 is measured by a Microtrac Nantrac Wave W3205 gauge. In order to perform the measurement, the ink is diluted into a 1:100 ratio and poured into a chamber of the gauge. The reflective index of the pigment material is inputted into the gauge. During operation of the gauge the wavelength of a light source passing through the diluted solution is collected and the wavelength date is then correlated into D50 particle size. In some embodiments, the titanium dioxide powder may be ground through conventional techniques to achieve a desired average particle size D50. In some embodiments, the uncured inkjet ink composition includes white pigment material in an amount in a range from 9 to 14 weight %, 9 to 13 weight %, 9 to 12 weight %, 9 to 11 weight %, 9 to 10 weight %, 10 to 14 weight %, 10 to 13 weight %, 10 to 12 weight %, 10 to 11 weight %, 11 to 14 weight %, 11 to 13 weight %, 11 to 12 weight %, 12 to 14 weight %, 12 to 13 weight %, 13 to 14 weight %, or any ranges or subranges therebetween. In some embodiments, the white pigment material provides white color to the ink, enables the ink to achieve a suitable optical density upon inkjet printing onto a substrate, and is a factor in maintaining suitable electrical resistance of the ink after it is printed and cured. In some embodiments, a pigment for use within the uncured inkjet ink composition is commercially available.

An uncured inkjet ink composition in accordance with various embodiments includes an uncured resin composition. The uncured resin composition of an uncured inkjet ink composition ensures adhesion of the particulate pigment material component to a substrate (i.e., particularly a glass substrate) and is able to encase the pigment material to prevent coagulation of the pigment material. Moreover, the uncured resin composition of an uncured inkjet ink composition assists when cured within the context of meeting or surpassing environmental reliability test criteria common with respect to a particular end application of an inkjet ink coated and cured substrate. The uncured resin composition of an uncured inkjet ink composition in accordance with some embodiments when cured may also ensure and provide additional functional attributes to a cured inkjet ink composition coated article, such as but not limited to solvent resistance and chemical resistance, and desirable electrical resistivity characteristics.

In some embodiments, uncured inkjet ink composition includes the uncured resin composition in a range from 25 to 32 weight %, 25 to 31 weight %, 25 to 30 weight %, 25 to 29 weight %, 25 to 28 weight %, 25 to 27 weight %, 25 to 26 weight %, 26 to 32 weight %, 26 to 31 weight %, 26 to 30 weight %, 26 to 29 weight %, 26 to 28 weight %, 26 to 27 weight %, 27 to 32 weight %, 27 to 31 weight %, 27 to 30 weight %, 27 to 29 weight %, 27 to 28 weight %, 28 to 32 weight %, 28 to 31 weight %, 28 to 30 weight %, 28 to 29 weight %, 29 to 32 weight %, 29 to 31 weight %, 29 to 30 weight %, 30 to 32 weight %, 30 to 31 weight %, 31 to 32 weight %, or any ranges or subranges therebetween.

In some embodiments the uncured resin composition includes, but is not necessarily limited to, an uncured silicone resin component. In some embodiments, the uncured inkjet ink composition includes the uncured silicone resin component in a range from 12 to 25 weight %, 12 to 22 weight %, 12 to 20 weight %, 12 to 18 weight %, 12 to 15 weight %, 15 to 25 weight %, 15 to 22 weight %, 15 to 20 weight %, 15 to 18 weight %, 18 to 25 weight %, 18 to 22 weight %, 18 to 20 weight %, 20 to 25 weight %, 20 to 22 weight %, 22 to 25 weight %, or any ranges or subranges therebetween.

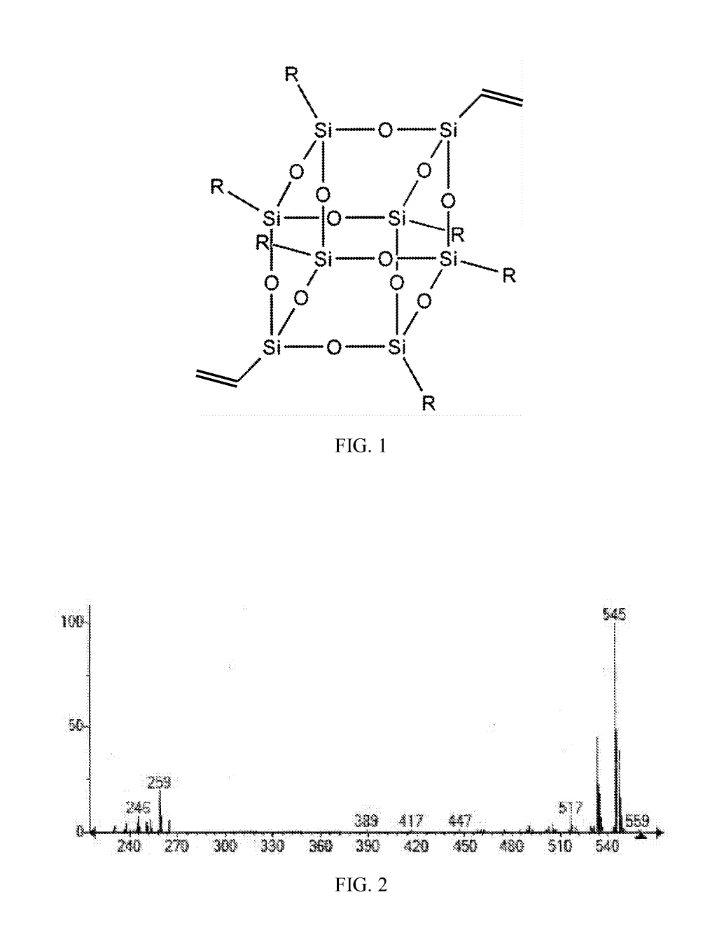

An uncured silicone resin component within an uncured inkjet ink composition in accordance with an embodiment comprises and may alternatively be defined as a silsesquioxane uncured silicone resin component, and such as (but not limited to) a divinyl-hexamethyl-octasila-silsesquioxane uncured silicone resin component (Vin₂Me₆Si₈) whose chemical structure is illustrated in FIG. 1. FIG. 2 is a thermal desorption gas chromatography mass spectrum of the divinyl-hexamethyl-octasila-silsesquioxane uncured silicone resin component.

As is understood by a person skilled in the art, the Vin₂Me₆Si₈ silsesquioxane uncured silicone resin component whose chemical structure is illustrated in FIG. 1 is a condensation product of two molecules of a vinyl-tri-substitutable silane and six molecules of a methyl-tri-substitutable silane. The tri-substitutable portions of the foregoing vinyl silane and methyl silane molecules may comprise, for example and without limitation, substitutable chemical functionality including but not limited to suitable halide functionality and suitable alkoxide functionality. Thus, suitable silane starting materials that may be used for preparing the silsesquioxane uncured silicone resin component whose chemical structure is illustrated in FIG. 1 may include, but are not limited to, vinyl-triethoxy-silane and methyl-trimethoxy-silane. The silsesquioxane uncured silicone resin component whose chemical structure is illustrated in FIG. 1 is present at approximately 12 to 25 weight percent of an uncured inkjet ink composition in accordance with some embodiments. The silsesquioxane uncured silicone resin component whose chemical structure is illustrated in FIG. 1 is further characterized as a transparent viscous fluid having about 30% to about 45% solids, a viscosity from about 10 to about 20 centipoise at 25° C., a density from about 0.9 to about 1.0 gram/cm³ at 23° C., and a surface tension from about 26 to about 29 dynes/cm.

A suitable uncured silicone resin component (i.e., including but not limited to the Vin₂Me₆Si₈ silsesquioxane whose chemical structure is illustrated in FIG. 1) for use within an uncured resin composition within an uncured inkjet ink composition in accordance with some embodiments is available from any of several commercial sources as an appropriately designated uncured silicone resin. As noted above, the uncured silicone resin component may alternatively be prepared in-situ from reaction of a 1:3 ratio of an appropriate vinyl silane and an appropriate methyl silane.

In some embodiments, in addition to the uncured silicone resin component, the uncured resin composition also includes one or more of an uncured amino resin component, an uncured acrylic resin component, and an uncured epoxy resin component. In some embodiments, the uncured inkjet ink composition includes the uncured acrylic resin component in a range from 0 to 10 weight %, 0 to 8 weight %, 0 to 6 weight %, 0 to 4 wt %, greater than 0 to 10 weight %, greater than 0 to 8 weight %, greater than 0 to 6 weight %, greater than 0 to 4 weight %, 2 to 10 weight %, 2 to 8 weight %, 2 to 6 weight %, 2 to 4 wt %, 4 to 10 weight %, 4 to 8 weight %, 4 to 6 weight %, 6 to 10 weight %, 6 to 8 weight %, 8 to 10 weight %, or any ranges or subranges therebetween. In some embodiments, the uncured inkjet ink composition includes the uncured amino resin component in a range from 0 to 10 weight %, 0 to 8 weight %, 0 to 6 weight %, 0 to 4 wt %, greater than 0 to 10 weight %, greater than 0 to 8 weight %, greater than 0 to 6 weight %, greater than 0 to 4 weight %, 2 to 10 weight %, 2 to 8 weight %, 2 to 6 weight %, 2 to 4 wt %, 4 to 10 weight %, 4 to 8 weight %, 4 to 6 weight %, 6 to 10 weight %, 6 to 8 weight %, 8 to 10 weight %, or any ranges or subranges therebetween. In some embodiments, the uncured inkjet ink composition includes the uncured epoxy resin component in a range from 0 to 10 weight %, 0 to 8 weight %, 0 to 6 weight %, 0 to 4 wt %, greater than 0 to 10 weight %, greater than 0 to 8 weight %, greater than 0 to 6 weight %, greater than 0 to 4 weight %, 2 to 10 weight %, 2 to 8 weight %, 2 to 6 weight %, 2 to 4 wt %, 4 to 10 weight %, 4 to 8 weight %, 4 to 6 weight %, 6 to 10 weight %, 6 to 8 weight %, 8 to 10 weight %, or any ranges or subranges therebetween. In some embodiments, the uncured amino resin component, the uncured acrylic resin component, and the uncured epoxy resin component for use within the uncured inkjet ink composition are commercially available.

An uncured inkjet ink composition in accordance with various embodiments includes a solvent composition. In general, in accordance with various embodiments, the solvent materials are selected to serve as a carrier for the pigment material particles, enabling the pigment material particles to be uniformly and smoothly ejected from a jet ink print head onto a non-porous substrate, such as but not limited to a glass substrate, a glass-ceramic substrate, a ceramic substrate, a metal oxide substrate, a metal substrate and/or a polymeric substrate. In addition, the solvent components are chosen to also control the drying, fluidic, and wetting properties of the uncured inkjet ink composition, as well as ensuring that the uncured inkjet ink composition viscosity and surface tension does not change with temperature, and thus maintains stable printing performance (e.g., infrequent clogging of print head nozzles). The solvent composition also adjusts the viscosity of the ink to balance having a low enough volatility to remain stable in storage and during use so that is does not dry or clog inkjet printhead nozzles with a high enough volatility to minimize or prevent excess flow of the ink and dewetting after inkjet printing onto the substrate. Moreover, it is anticipated that the solvent composition within an uncured inkjet ink composition in accordance with an embodiment may be characterized using a gas chromatography analysis at 200° C.

In some embodiments, uncured inkjet ink composition includes the solvent composition in a range from 50 to 60 weight %, 50 to 59 weight %, 50 to 58 weight %, 50 to 57 weight %, 50 to 56 weight %, 50 to 55 weight %, 50 to 54 weight %, 50 to 53 weight %, 50 to 52 weight %, 50 to 51 weight %, 51 to 60 weight %, 51 to 59 weight %, 51 to 58 weight %, 51 to 57 weight %, 51 to 56 weight %, 51 to 55 weight %, 51 to 54 weight %, 51 to 53 weight %, 51 to 52 weight %, 52 to 60 weight %, 52 to 59 weight %, 52 to 58 weight %, 52 to 57 weight %, 52 to 56 weight %, 52 to 55 weight %, 52 to 54 weight %, 52 to 53 weight %, 53 to 60 weight %, 53 to 59 weight %, 53 to 58 weight %, 53 to 57 weight %, 53 to 56 weight %, 53 to 55 weight %, 53 to 54 weight %, 54 to 60 weight %, 54 5 to 60 weight %, 55 to 59 weight %, 55 to 58 weight %, 55 to 57 weight %, 55 to 56 weight %, 56 to 60 weight %, 56 to 59 weight %, 56 to 58 weight %, 56 to 57 weight %, 57 to 60 weight %, 57 to 59 weight %, 57 to 58 weight %, 58 to 60 weight %, 58 to 59 weight %, 59 to 60 weight %, or any ranges or subranges therebetween.

In some embodiments, the solvent composition includes, but is not necessarily limited to: (1) a propylene-glycol-ether (such as propylene-glycol-monomethyl-ether) (2) diethylene-glycol-dimethyl-ether, (3) propylene-glycol-methyl-ether-acetate, (4) diethylene-glycol-diethyl ether and (5) any combinations thereof (e.g., two, three, or all four of the listed solvents). In some embodiments, solvents for use within the uncured inkjet ink composition are commercially available.

In some embodiments, the uncured inkjet ink composition includes propylene-glycol-ether in a range from 15 to 25 weight %, 15 to 22 weight %, 15 to 20 weight %, 15 to 18 weight %, 18 to 25 weight %, 18 to 22 weight %, 18 to 20 weight %, 20 to 25 weight %, 20 to 22 weight %, 22 to 25 weight %, or any ranges or subranges therebetween. In some embodiments, the uncured inkjet ink composition includes diethylene-glycol-dimethyl-ether in a range from 10 to 20 weight %, 10 to 18 weight %, 10 to 16 weight %, 10 to 12 weight %, 12 to 20 weight %, 12 to 18 weight %, 12 to 16 weight %, 12 to 14 weight %, 14 to 20 weight %, 14 to 18 weight %, 14 to 16 weight %, 16 to 20 weight %, 16 to 18 weight %, 18 to 20 weight %, or any ranges or subranges therebetween. In some embodiments, the uncured inkjet ink composition includes propylene-glycol-methyl-ether-acetate in a range from 13 to 25 weight %, 13 to 22 weight %, 13 to 20 weight %, 13 to 18 weight %, 13 to 15 weight %, 15 to 25 weight %, 15 to 22 weight %, 15 to 20 weight %, 15 to 18 weight %, 18 to 25 weight %, 18 to 22 weight %, 18 to 20 weight %, 20 to 25 weight %, 20 to 22 weight %, 22 to 25 weight %, or any ranges or subranges therebetween. In some embodiments, the uncured inkjet ink composition includes diethylene-glycol-diethyl ether in a range from 0 to 10 weight %, 0 to 8 weight %, 0 to 6 weight %, 0 to 4 wt %, greater than 0 to 10 weight %, greater than 0 to 8 weight %, greater than 0 to 6 weight %, greater than 0 to 4 weight %, 2 to 10 weight %, 2 to 8 weight %, 2 to 6 weight %, 2 to 4 wt %, 4 to 10 weight %, 4 to 8 weight %, 4 to 6 weight %, 6 to 10 weight %, 6 to 8 weight %, 8 to 10 weight %, or any ranges or subranges therebetween.

In some embodiments, among many other components, the solvent may include one or more of the following components, including ethanol, isopropyl alcohol, n-butyl alcohol, isobutyl alcohol, ethylene glycol, glycerol, 3-methoxy-3-methyl-1-butanol, 1,2-propanediol, 1,3-propanediol, 2-ethyl-2-(hydroxymethyl)-1 3-propanediol, 2-butyl-2-ethyl-1,3-propanediol, 2,2-dimethylpropane-1,3-diol, 1,2-butylene glycol, 1,3-butylene glycol, 2,3-butylene glycol, 2,2-dimethyl-1,3-propanediol, 1,5-pentanediol, 2-methyl-1,4-pentadiene, 2,4-diethyl-2,4-pentanediol, 2-butene-1 4-diol, 2,5-hexanediol, 2,5-dimethylhexane-2,5-diol, 2-ethyl-1,3-hexanediol, ethylene glycol dimethyl ether, tetraethylene glycol dimethyl ether, dipropylene glycol dimethyl ether, diethylene glycol dibutyl ether, diethylene glycol monobutyl ether, diethylene glycol dimethyl ether, ethylene glycol diethyl ether, diethylene glycol diethyl ether, diethylene glycol methyl ethyl ether, propylene glycol dimethyl ether, triethylene glycol dimethyl ether, ethylene glycol tertiary butyl ether, ethylene glycol monobutyl ether, propylene glycol tertiary butyl ether, diethylene glycol tertiary butyl ether, propylene glycol monomethyl ether, propylene glycol methyl propylene ether, propylene glycol methyl butyl ether, dipropylene glycol methyl butyl ether, dipropylene glycol methyl propylene ether, ethylene glycol monoethyl ether acetate, diethylene glycol monobutyl ether acetate, diethylene glycol monoethyl ether acetate, propylene glycol methyl ether acetate, dipropylene glycol methyl ether acetate, and/or ethylene glycol monobutyl ether acetate, among many others.

In some embodiments, the uncured inkjet ink composition can also include a dispersant intended to keep the pigment component particles uniformly suspended even after being mixed into a paste and/or into the uncured inkjet ink composition, and to prevent coagulation or sedimentation. Coagulated pigment material component particles may clog inkjet ink nozzles, cause point defects when printed onto substrates and dramatically reduce electrical resistivity of a cured inkjet ink composition. Nanometer-sized pigment material component particles are more susceptible to coagulation in comparison with larger sized pigment material component particles, due to stronger van der Waal forces, for example. In some embodiments, the uncured inkjet ink composition includes a dispersant in a range from 1 to 4 weight %, 1 to 3 weight %, 1 to 2 weight %, 2 to 4 weight %, 2 to 3 weight %, 3 to 4 weight %, or any ranges or sub-ranges therebetween.

In some embodiments, a dispersant material may include an acrylic polymer material. As just one example, an acrylic polymer material dispersant suitable for compatibility with an uncured resin component and a solvent composition in accordance with an embodiment is commercially available. According to other embodiments, the dispersant may be or may include one or more of the following, including but not limited to a polyurethane and/or polymethyl-methacrylate copolymer dispersant, an acrylate copolymer with pigment affinity groups, a high molecular weight block copolymer with pigment affinic groups, a polycarboxylic acid salt of polyamine amides, alkylol ammonium salt of a copolymer with acidic groups, a phosphoric ester salt of a high molecular weight copolymer with pigment-affinity groups, and/or a hydroxy-functional carboxylic acid ester with pigment affinity groups, among others. In some embodiments, dispersants for use within the uncured inkjet ink composition are commercially available.

According to some embodiments, the uncured inkjet ink composition can also include a flow promotor that improves the wetting of an uncured inkjet ink composition onto a substrate (for example, a glass, glass-ceramic, ceramic, metal oxide, metal, and/or polymeric substrate), thus preventing de-wetting of the uncured inkjet ink composition from a substrate prior to curing. In some embodiments, the uncured inkjet ink composition includes a flow promotor in a range from 0.5 to 3.5 weight %, 0.5 to 3 weight %, 0.5 to 2.5 weight %, 0.5 to 2 weight %, 0.5 to 1.5 weight %, 0.5 to 1 weight %, 1 to 3.5 weight %, 1 to 3 weight %, 1 to 2.5 weight %, 1 to 2 weight %, 1 to 1.5 weight %, 1.5 to 3.5 weight %, 1.5 to 3 weight %, 1.5 to 2.5 weight %, 1.5 to 2 weight %, 2 to 3.5 weight %, 2 to 3 weight %, 2 to 2.5 weight %, 2.5 to 3.5 weight %, 2.5 to 3 weight %, 3 to 3.5 weight %, or any ranges and sub-ranges therebetween. In some embodiments, the flow promotor may be a modified polyether polydimethylsiloxane. In some embodiments, flow promotors for use within the uncured inkjet ink composition are commercially available.

According to some embodiments, the inkjet ink composition can also include a surface control agent including but not limited to a polydimethylsiloxane solution, a polyether polyester modified organic siloxane solution, an alkyl modified organic siloxane solution, an acrylate copolymer, a polyacrylate solution, an OH, and/or a polyacrylate copolymer with OH functional groups solution, among others. A degassing agent may be, for example, a polydimethylsiloxane and/or a modified polydimethylsiloxane.

Further details relating to the uncured inkjet ink composition in accordance with various embodiments described and/or otherwise envisioned are as follows.

Provided in Tables 1 and 2 are variations of an uncured white inkjet ink composition in accordance with several embodiments.

TABLE 1
White Inkjet Ink Composition

| Component | (weight percent) |
|---|---|
| Pigment material (titanium dioxide powder) | 9-14 |
| Dispersant | 1-4 |
| Silicone resin component | 12-25 |
| Epoxy resin component | 0-10 |
| Amino resin component | 0-10 |
| Acrylic resin component | 0-10 |
| Propylene glycol monomethyl ether | 15-25 |
| Diethylene glycol dimethyl ether | 10.0-20.0 |
| Diethylene glycol diethyl ether | 0-10 |
| Propylene glycol methyl ether acetate | 13-25 |
| Flow promoter | 0.5-3.5 |

TABLE 2
White Inkjet Ink Composition

| Component | (weight percent) |
|---|---|
| Titanium dioxide powder (pigment) | 12.8 |
| Acrylic polymer dispersant | 3 |
| Silicone resin component | 18.5 |
| Amino resin component | 5.5 |
| Acrylic resin component | 4.5 |
| Propylene glycol monomethyl ether | 23.3 |
| Diethylene glycol dimethyl ether | 12.7 |
| Diethylene glycol diethyl ether | 3.1 |
| Propylene glycol methyl ether acetate | 15.3 |
| Polyether modified polydimethylsiloxane | 1.3 |
| (flow promoter) | |

Beyond the foregoing components including the pigment component, the resin component, and the solvent composition, an uncured inkjet ink composition in accordance with some embodiments, may also further comprise one or more other additives that may be otherwise conventional or unconventional within the context of uncured inkjet ink compositions. Such additional additives may include, but are not necessarily limited to, a resin strengthener that may be present up to approximately 3 percent and comprise a conventional composition.

An uncured inkjet ink composition in accordance with some embodiments may be prepared by mixing the foregoing components in any order, until a uniform suspension of the uncured inkjet ink composition is obtained. Typically and preferably, the sum of the components is mixed and appropriately adjusted to provide an uncured inkjet ink composition that has a viscosity suitable for inkjet printing (an inkjet printable ink composition), for example from 2 to 6 centipoise, 2 to 5 centipoise, 2 to 4 centipoise, 2 to 3 centipoise, 3 to 6 centipoise, 3 to 5 centipoise, 3 to 4 centipoise, 4 to 6 centipoise, 4 to 5 centipoise, or 5 to 6 centipoise at 25 degrees Celsius, or any ranges and sub-ranges therebetween.

In some embodiments, the inkjet ink compositions disclosed herein are thermally curable. Thus in some embodiments, the inkjet ink compositions disclosed herein are not curable upon exposure to ultraviolet light (not uv-curable) and/or are non-aqueous (do not contain water). In some embodiments, the thermally curable inkjet ink compositions do not contain a photoinitiator component that initiates curing upon exposure to ultraviolet light. In some embodiments, the solvent composition of the inkjet ink compositions is non-aqueous.

Inkjet Ink Composition Coating Methods

An inkjet ink coating method in accordance with an embodiment parallels generally the inkjet ink composition in accordance with the above description. Thus, in some embodiments, an uncured inkjet ink composition according to any of the embodiments described herein is coated upon a substrate. Next, the uncured inkjet ink composition is cured in-situ upon the substrate to form a cured inkjet ink composition coating upon the substrate. In some embodiments, the inkjet ink composition is applied directly to the surface of the substrate (e.g., without previous application of a primer). In other embodiments, a primer may be applied to the surface of the substrate prior to applying the inkjet ink composition to assist in adhesion of the ink to the surface of the substrate.

According to some embodiments, the coating method could first include the step of formulating the uncured inkjet ink composition. Generating or formulating the uncured inkjet ink composition could include, for example, the step of combining or mixing the pigment material, the inorganic resin component, and the solvent composition. The step of generating or formulating the uncured inkjet ink composition could also include a prior step of mixing grinding into, or otherwise combining a dispersant with one or more pigments to make a pigment paste. The pigment paste, with the dispersant material pre-mixed, can be commercially available in accordance with an embodiment. The pigment paste can be mixed with the resin component and the solvent mixture, or mixed with a pre-combined mixture of the resin and solvent, to form the uncured inkjet ink composition.

In some embodiments, the uncured inkjet ink composition is thermally cured to form the cured inkjet ink composition coating. Such thermal curing of the uncured inkjet ink composition to provide the cured inkjet ink composition coating may be performed in a convection oven or an infrared oven, for example. In some embodiments, the thermal curing may occur in an inert atmosphere. In some embodiments, the thermal curing of the inkjet ink composition may be a single heating step or a multiple heating steps. In some embodiments, the thermal curing may occur at a temperature in a range from 160 to 250 degrees Celsius for a time period in a range from 1 to 20 minutes. In some embodiments, a baking step may occur after the thermal curing step. In some embodiments, the baking step may occur at a temperature in a range from 125 to 175 degrees Celsius for a time period in a range from 15 to 60 minutes.

In some embodiments, prior to curing, the inkjet ink composition may be heated at a temperature sufficient to evaporate a portion of the solvent composition but not thermally cure the inkjet ink composition in order to minimize and/or prevent the ink from flowing once applied to the substrate. In some embodiments the substrate may be placed on a heating plate to provide the heat sufficient to evaporate a portion of the solvent composition but not thermally cure the inkjet ink composition. In some embodiments, the heating plate may be heated to a temperature in a range from 25 to 75 degrees Celsius.

Consistent with aspects of an embodiment as discussed above, an uncured inkjet ink composition in accordance with an embodiment is coated and cured upon a substrate selected from the group including but not limited to a glass substrate, a glass-ceramic substrate, a ceramic substrate, a metal oxide substrate, a metal substrate, and/or a polymeric substrate, among others. Particular end product applications of such substrates are varied.

The foregoing substrate selection options and uncured inkjet ink composition coating and thermal processing curing conditions are not intended to limit an embodiment with respect to any particular functional end result. Rather, an embodiment intend and expect that alternative thermal processing curing conditions may be accessed to realize specific thermally cured inkjet ink composition coated substrates.

Cured Inkjet Ink Composition Coated Articles

Following in sequence from the foregoing uncured inkjet ink composition and method for coating the foregoing inkjet ink composition to provide a cured inkjet ink composition coated article, is the cured inkjet ink composition coated article itself. Such a cured inkjet ink coated article includes a substrate as well as the cured inkjet ink composition coating located upon the substrate. The cured coating includes a pigment, as well as a cured inorganic resin binder composition. Desirably, within a coated article in accordance with an embodiment the substrate is selected from the group consisting of a glass substrate, a glass-ceramic substrate, a ceramic substrate, a metal oxide substrate, a metal substrate, and/or a polymeric substrate among others. In some embodiments, the coated article may be incorporated into an electronic device as part of a housing or as a cover assembly. In some embodiments, the electronic device may include, but is not limited to, a mobile phone, a laptop, or a tablet.

In some embodiments, the cured coating has an optical density greater than 0.2 to 1.0, greater than 0.2 to 0.8, greater than 0.2 to 0.6, greater than 0.3 to 1.0, greater than 0.3 to 0.8, greater than 0.3 to 0.6, greater than 0.4 to 1.0, greater than 0.4 to 0.8, greater than 0.4 to 0.6, greater than 0.5 to 1.0, greater than 0.5 to 0.8, greater than 0.5 to 0.6, greater than 0.55 to 1.0, greater than 0.55 to 0.8, greater than 0.6 to 1.0, greater than 0.6 to 0.8, or any ranges and sub-ranges therebetween. The optical density may be measured using an X-rite 361T transmission gauge. In some embodiments, the optical density may be controlled and adjusted by controlling the amount of ink deposited from an inkjet printer printhead. In some embodiments, the cured coating has a thickness suitable to achieve the desired optical density for example in a range from 1 to 10 microns, 1 to 8 microns, 1 to 6 microns, 1 to 4 microns, 2 to 10 microns, 2 to 8 microns, 2 to 6 microns, 2 to 4 microns, 3 to 10 microns, 3 to 8 microns, 3 to 6 microns, 3 to 4 microns, 4 to 10 microns, 4 to 8 microns, 4 to 6 microns, or any ranges and sub-ranges therebetween.

In some embodiments, the cured inkjet ink composition coating has an adhesion to the substrate of 4B or greater as measured using a Gardco cross-hatch adhesion kit in accordance with ASTM D3359-09e2 (and its progeny), which is incorporated herein by reference in its entirety. In some embodiments, the cured inkjet ink composition coating meets standard reliability and environmental tests for inks including thermal cycle testing for 72 hours, high temperature/high humidity testing for 87 hours, chemical resistance testing for 72 hours, salty water testing for 72 hours, snap tape test, and UV exposure testing for 72 hours. According to some embodiments, within the cured coating the pigment component particles are regularly arranged. Finally, the cured inkjet ink resin composition within the cured coated article in accordance with an embodiment may be chemically characterized using standard methodology.

It will be apparent to those skilled in the art that various modifications and variations can be made without departing from the spirit or scope of the claims.

What is claimed is:

1. An ink composition comprising:
a white pigment material;
a resin composition comprising:
a silicone resin component; and
at least one of an amino resin component or an acrylic resin component; and
a solvent composition comprising one or more of a propylene-glycol-ether, diethylene-glycol-dimethyl-ether, propylene-glycol-methyl-ether-acetate, or diethylene-glycol-diethyl ether.

2. The ink composition of claim 1, wherein the ink composition is inkjet printable and thermally curable.

3. The ink composition of claim 1, wherein the white pigment material comprises a titanium dioxide powder having an average particle size D50 in a range from 100 nm to 250 nm.

4. The ink composition of claim 3, wherein the average particle size D50 is in a range from 150 nm to 250 nm.

5. The ink composition of claim 1, wherein the silicone resin component comprises a silsesquioxane.

6. The ink composition of claim 5, wherein the silsesquioxane is divinyl-hexamethyl-octasila-silsesquioxane.

7. The ink composition of claim 1, wherein the solvent composition comprises two or more of a propylene-glycol-ether, diethylene-glycol-dimethyl-ether, propylene-glycol-methyl-ether-acetate, or diethylene-glycol-diethyl ether.

8. The ink composition of claim 1, wherein the solvent composition comprises three or more of a propylene-glycol-ether, diethylene-glycol-dimethyl-ether, propylene-glycol-methyl-ether-acetate, or diethylene-glycol-diethyl ether.

9. The ink composition of claim 1, wherein the solvent composition comprises propylene-glycol-ether, diethylene-glycol-dimethyl-ether, propylene-glycol-methyl-ether-acetate, and diethylene-glycol-diethyl ether.

10. The ink composition of claim 1, wherein the propylene-glycol-ether is propylene-glycol-monomethyl-ether.

11. The ink composition of claim 1, further comprising:
a dispersant; and
a flow promoter.

12. The ink composition of claim 11, wherein the flow promoter comprises modified polyether polydimethylsiloxane.

13. The ink composition of claim 1, wherein the resin composition comprises an amino resin component and an acrylic resin component.

14. The ink composition of claim 1, wherein the resin composition further comprises an epoxy resin component.

15. The ink composition of claim 1, comprising:
the pigment material in a range from 9 to 14 weight percent;
the silicone resin component in a range from 12 to 25 weight percent;
the amino resin component in a range from 0 to 10 weight percent;
the acrylic resin component in a range from 0 to 10 weight percent;
the propylene-glycol-ether in a range from 15 to 25 weight percent;
diethylene-glycol-dimethyl-ether in a range from 10 to 20 weight percent;
diethylene-glycol-diethyl ether in a range from 0 to 10 weight percent; and
propylene-glycol-methyl-ether-acetate in a range from 13 to 25 weight percent.

16. The ink composition of claim 15 further comprising:
a dispersant in a range from 1 to 4 weight percent;
a flow promoter in a range from 0.5 to 3.5 weight percent; and
an epoxy resin component in a range from 0 to 10 weight percent.

17. An ink coating method comprising the steps of:
coating upon a substrate an uncured inkjet ink composition; and
curing in-situ the uncured inkjet ink composition to form a cured ink composition upon the substrate.

18. The method of claim 17, wherein the substrate is selected from the group consisting of a glass substrate, a glass-ceramic substrate, a ceramic substrate, a metal oxide substrate, a metal substrate, and a polymeric substrate.

19. The method of claim 17, wherein the uncured inkjet ink composition is thermally cured to form the cured ink composition.

20. The method of claim 17, wherein the cured ink composition has an optical density in a range from greater than 0.2 to 1.0.

21. The method of claim 20, wherein the cured ink composition has an optical density in a range from greater than 0.5 to 1.0.

22. A coated article, the coated article comprising:
a substrate; and
a cured coating located upon the substrate, the cured coating comprising the ink composition of claim 1.

23. The coated article of claim 22, wherein the cured coating has a thickness in a range from 1 micron to 10 microns.

24. The coated article of claim 22, wherein the cured coating has an optical density in a range from greater than 0.2 to 1.0.

25. The coated article of claim 24, wherein the cured coating has an optical density in a range from greater than 0.5 to 1.0.

26. The coated article of claim 22, wherein the adhesion of the cured coating to the substrate is greater than or equal to 4B according to a cross hatch adhesion test set forth in ASTM D3359-09e2.

27. An electronic device comprising the coated article of claim 22.
